(19) United States
(12) Patent Application Publication
(10) Pub. No.: US 2018/0198786 A1
(43) Pub. Date: Jul. 12, 2018

(54) ASSOCIATING LAYER 2 AND LAYER 3 SESSIONS FOR ACCESS CONTROL

(71) Applicant: Pulse Secure, LLC, San Jose, CA (US)

(72) Inventors: Viral Ileshkumar Shah, Bangalore (IN); Clifford E. Kahn, Westford, MA (US); Jonathan Rausch, Townsend, MA (US); Lenson Andrade, Bangalore (IN)

(21) Appl. No.: 15/868,644

(22) Filed: Jan. 11, 2018

(30) Foreign Application Priority Data
Jan. 11, 2017 (IN) 201741001165

(51) Int. Cl. H04L 29/06

(52) U.S. Cl. CPC H04L 63/0876; H04L 63/20; H04L 63/083; H04L 63/0823; H04L 63/108

(57) ABSTRACT

A network access control (NAC) device enforces one or more policies for accessing one or more remote network devices. The NAC device includes a processor configured to receive authentication credentials from the user device over an L2 connection including first identification information of the user device, authenticate the user device using the authentication credentials, receive compliance information from the user device over an L3 connection including second identification information of the user device, associate the L2 connection with the L3 connection using the first identification information and the second identification information, and in response to determining that the compliance information satisfies the one or more policies, authorize the user device to access the one or more remote network devices.

This application claims the benefit of India Patent Application No. 201741001165, filed Jan. 11, 2017, which is hereby incorporated by reference in its entirety.

### TECHNICAL FIELD

This disclosure relates to network devices, and in particular, access control for network devices.

### COPYRIGHT NOTICE

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Network Access Control (NAC) devices of private networks intercept end user requests for network access. In a typical private network environment, a NAC device provides network access control for on-premise access requests. On-premise access requests are characterized as access requests that are receive through a network control device or access point that is considered part of the private network infrastructure. Conversely, off-premise access requests for access originate from network control devices or access points that are outside the private network infrastructure.

While on-premise access requests usually do not result in forming a virtual private network (VPN) tunnel to authorize or authenticate an end user device, some of the private network infrastructure may include network control devices that are connected to the private network over a VPN tunnel and some of the on premise authorization and authentication activity may utilize VPN tunnels that are already part of the private network.

Conventional NAC devices intercept network access requests and perform and/or manage identifying information checks (e.g., user name and password checks and/or certificate checks) to authenticate a user and/or a device used by the user. That is, NAC devices may perform authentication to determine whether the end user device and its user are authorized to use the network. Initial exchanges between the end user device and the NAC device are typically over the data-link layer or layer 2 (L2) of the OSI model. If the end user device is authorized to access the private network, based on the authorization check performed by the NAC device on L2, the NAC device approves or authorizes the end user device limited access to the private network but only on L2.

While user name and password authorization can be performed on L2, a policy compliance check of the end user device is generally performed at higher OSI model layer, e.g. L3 the L7. Thus, after authenticating a user name and password, the NAC device performs a compliance check of the end user device to determine if the end user device is in compliance with current policies of the enterprise network. The current policies may be stored on the NAC device or on a separate policy server in communication with the NAC device. If the end user device is found to be in compliance with current policies of the private network, the NAC device grants the end user device a higher level of access (e.g., full access) to the private network. If the end user device is found not to be compliance with current policies, the NAC device may deny the end user device access to the private network, or at least until the end user device has been brought into compliance, e.g., by providing the end user device with access to a remediation server or module to be used to bring the end user device into compliance.

The current policies may include, an acceptable operating system updated to a particular revision or other update state, an acceptable virus/malware/spyware protection program updated to a particular revision or update state, an agent module of the private network operating on the end user device wherein the agent module operates to evaluate a policy compliance state of the end user device, or the like, a firewall type and its settings, a browser type and its settings, or the like. Additionally or alternatively, the current policies may require that certain applications—plug-ins, add-ons, or the like—are not running on the end user device.

A conventional NAC device associated with a private network may include an authorization module, or may outsource authorization to an authorization module operating on another device included other devices outside the private network infrastructure such as authentication server. Similarly a conventional NAC device associated with a private network may include a policy module and/or a policy authentication module, or may outsource policy authentication to an authentication module operating on another device included other devices outside the private network infrastructure such as authentication server.

Remote Authentication Dial-In User Service (RADIUS) is a conventional client/server protocol and software that enables remote access services, e.g., an end user device, to communicate with a central server, such as a NAC, to authenticate remote users and authorize their access to the requested system or server. The RADIUS protocol is widely used and is preferred by many private network administrators. The RADIUS protocol at least requires a point-to-point protocol (PPP) connection between the RADIUS client and the end user device, which at least requires establishing a network layer connection or a layer 3 (L3) connection on the Open System Interconnection (OSI) model.

The Extensible Authentication Protocol (EAP) and the Extensible Authentication Protocol over LAN (EAPOL), each defined in IEEE 802.1x, are conventional authorization and authentication protocols usable as an interface between an end user device and a RADIUS client to facilitate authorization and/or authentication of end user devices attempting to access a private network from a LAN and WLAN using the RADIUS protocol and/or a RADIUS server. One part of the authorization and authentication process of EAP and EAPOL is carried out over an L2 connection, and another part of the authorization and authentication process is carried out over an L3 connection. As a result, the authorization and authentication are conducted as two separate and unrelated events that are not tied together.

### SUMMARY

In general, this disclosure describes techniques for determining whether to grant a user device access to a network. In one example, the user device initially provides authentication credentials to a network access control (NAC) device via a data link layer, or layer two (L2), communication channel. If the NAC device determines that the authentication credentials are authentic, the NAC device grants the user device limited access, which allows the user device to, e.g., obtain an IP address and establish a network layer, or layer 3 (L3), communication channel, but does not allow the user device to access protected resources of the network. The user device then sends compliance information indicating whether or not the user device is in compliance with various network policies to the NAC device via the L3 communication channel. The NAC device associates the L3 communication channel with the L2 communication channel in order to determine that the compliance information is associated with an authenticated user. The NAC device further determines whether the compliance information indicates that the user device complies with one or more applicable policies. The NAC device may then either grant the user device full network access, or send remediation information to the user device to bring the user device into compliance with the applicable policies.

In one example, a method includes receiving, by a network access control (NAC) device that enforces one or more policies for accessing one or more remote network devices, authentication credentials from a user device via an OSI layer 2 (L2) connection including first identification information of the user device, authenticating, by the NAC device, the user device using the authentication credentials, receiving, by the NAC device, compliance information from the user device via an OSI layer 3 (L3) connection including second identification information of the user device, associating, by the NAC device, the L2 connection with the L3 connection using the first identification information and the second identification information, and in response to determining that the compliance information satisfies the one or more policies, authorizing, by the NAC device, the user device to access the one or more remote network devices.

In another example, a network access control (NAC) device that enforces one or more policies for accessing one or more remote network devices, the NAC device comprising one or more network interfaces configured to communicate with a user device via a network; and one or more processors implemented in circuitry and configured to receive authentication credentials from the user device over an OSI layer 2 (L2) connection via the one or more network interfaces, the authentication credentials including first identification information of the user device, authenticate the user device using the authentication credentials, receive compliance information from the user device over an OSI layer 3 (L3) connection via the one or more network interfaces, the compliance information including second identification information of the user device, associate the L2 connection with the L3 connection using the first identification information and the second identification information, and in response to determining that the compliance information satisfies the one or more policies, authorize the user device to access the one or more remote network devices.

In another example, a computer-readable medium, such as a computer-readable storage medium, has stored thereon instructions that cause a processor of a network access control (NAC) device that enforces one or more policies for accessing one or more remote network devices to receive authentication credentials from the user device over an OSI layer 2 (L2) connection via the one or more network interfaces, the authentication credentials including first identification information of the user device, authenticate the user device using the authentication credentials, receive compliance information from the user device over an OSI layer 3 (L3) connection via the one or more network interfaces, the compliance information including second identification information of the user device, associate the L2 connection with the L3 connection using the first identification information and the second identification information, and in response to determining that the compliance information satisfies the one or more policies, authorize the user device to access the one or more remote network devices.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example network system including devices that may be configured to perform various techniques of this disclosure.

FIG. 2 is a block diagram illustrating an example network device according to the techniques of this disclosure.

FIG. 3 is a block diagram illustrating an example user device according to the techniques of this disclosure.

FIG. 4 is a block diagram illustrating an example network access control (NAC) device according to the techniques of this disclosure.

FIG. 5 is a block diagram illustrating an example wireless local area network (LAN) controller (WLC) device according to the techniques of this disclosure.

FIG. 6 is a flowchart illustrating an example method for authenticating and authorizing a user device to access one or more protected resources according to the techniques of this disclosure.

### DETAILED DESCRIPTION

Techniques are described that provide technical solutions to the problem of having two unrelated communication channels established between a user device attempting to gain access to a private network over a network access device, (NAC) from a local area network (LAN). In various examples, in order to gain access to protected resources of the private network a first communication channel is established between the user device and a local area network controller WLC, LC or gateway over the data-link layer or over level two (L2) of the OSI model. Thereafter a second communication channel is established between the user device and the NAC device over a local area network controller WLC, LC or gateway over the network layer or over level three (L3) of the OSI model.

According to one example implementation of the present invention, the first communication channel is used to establish an L2 communication channel with the user device in order to request by the NAC device an authorized user name and password or digital certificate from the user device and in order to transmit the authorized user name and password or digital certificate from the user device to the NAC device. Thereafter if the user name and password combination is deemed to be authorized by the NAC device the user device is granted limited access to the private network, on L2, but not to protected resources. As part of the authorization process the NAC device creates an L2 channel record in a database module operating on the NAC device, policy server or a database module reachable by the NAC device. The L2 channel record includes L2 channel attributes and user device authorization details at least including a MAC address of the user device, and the end user credentials used to authenticate, e.g., user name and password or digital certificate. Other L2 channel attributes may include date and time, gateway and/or local area network controller credentials, session length, or the like. Since one policy of the private network is to not provide access to the protected resources unless the user device has been deemed to be compliant with current network policies and since the compliance check is not performed on an L2 communication channel, a higher OSI layer connection is needed, e.g., L3 or higher, in order to perform a compliance check of the user device.

After the user device has been granted limited access to private network, on L2, the user device broadcasts a DHCP request to a DHCP server requesting an IP address and additional IP information. The DHCP request is broadcast over the L2 communication channel. In response to the DHCP request the user device is assigned and IP address.

After being assigned an IP address, the user device establishes the second communication channel with the NAC device over the network layer, or layer 3, L3 of the OSI model. Thereafter the NAC device or the policy server communicates with the user device, over L3, in order to determine if the user device is in compliance with one or more policies of the private network. If the user device is found to be in compliance with the policies of the private network, the NAC device grants the user device full-access status, e.g., on all OSI layers. The NAC device then finds the L2 database record associated with the first L2 communication used to authenticate the user name and password of the user device by searching database records for the user device Media Access Control (MAC) address, user name and password or other end user credentials. After finding the corresponding L2 record, the NAC device updates the L2 database record to include details of the second L3 channel communication such as L3 channel attributes and end point compliance details received over the L3 channel communication. The L3 channel attributes at least include the user device IP address and may include date and time, gateway and/or local area network controller credentials, session length, or the like. The end point compliance details may include device type, operating system, virus protection status, and other details or a PASS FAIL indictor. In particular, after updating the L2 record with the L3 channel attributes and compliance details retrieved over the L3 channel, all of the user device authentication records are associated with the L2 record. Alternately the L2 and L3 communication channels may be established between the user device and the authentication server. In this case the authentication server authorizes the user name and password on L2 and sends or shares the L2 channel attributes and user device authorization details with the NAC device before the NAC device makes any access decisions. Similarly, the authentication server authenticates that the user device is in compliance with policies of the private network and sends or shares the L3 channel attributes and user device compliance authentication details with the NAC device before the NAC device makes any further access decisions about the user device. However even when the authentication server is used instead of the NAC device, the NAC device still records the L2 communication details in an L2 databases record and the updates the L2 database record with L3 communication details such that all of the L2 attributes and authorization records and all of the L3 attributes and end point compliance details are stored in a single database record searchable by user device MAC address.

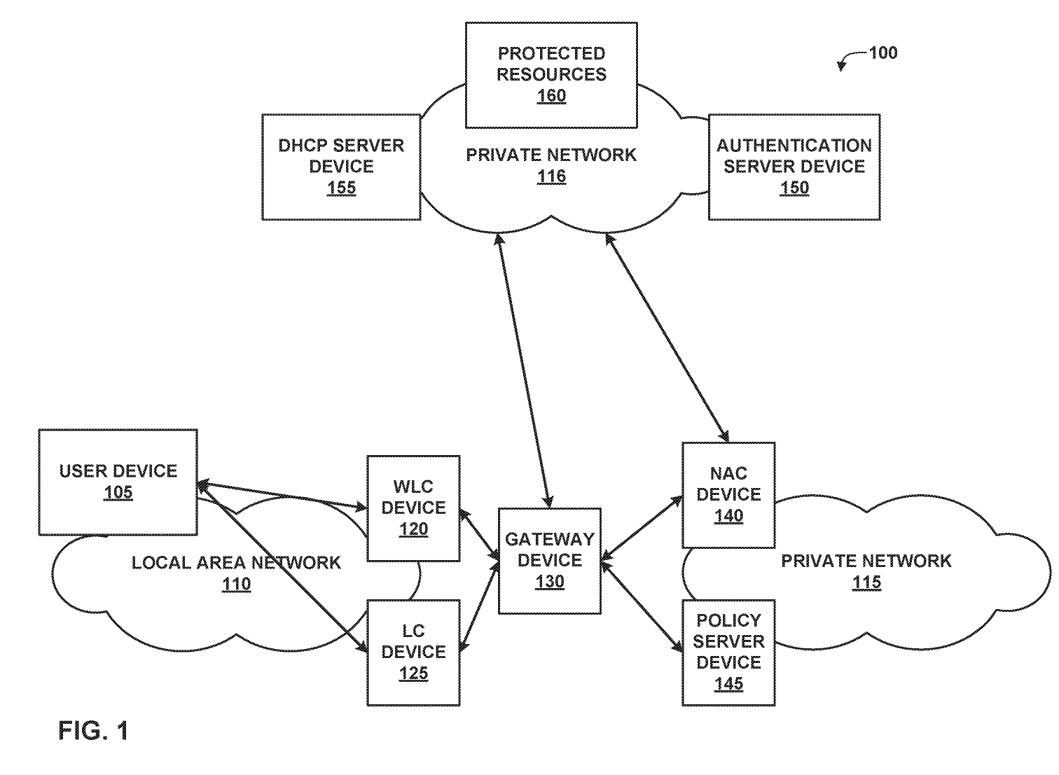

FIG. 1 is a block diagram illustrating an example network system 100 including devices that may be configured to perform various techniques of this disclosure. Network system 100 may represent an Intranet infrastructure, in some examples. In the example of FIG. 1, network system 100 includes local area network (LAN) 110, private network 115, and private network 116. Network system 100 also includes user device 105, wireless LAN controller (WLC) device 120, and LAN controller (LC) device 125, which form part of LAN 110. Network system 100 also includes network access control (NAC) device 140 and policy server device 145, which form part of private network 115. Network system 100 also includes dynamic host configuration protocol (DHCP) server device 155, authentication server device 150, and protected resources 160, which form part of private network 116. Network system 100 may include an Intranet infrastructure that includes first private network 115 and second private network 116, as well as LAN 110. In some examples, private network 115 and private network 116 may form the same private network (e.g., two parts or portions of the same private network). Network system 100 also includes gateway device 130.

In general, LAN 110 is remote relative to private networks 115, 116. A user may operate user device 105 to gain access to protected resources 160 of private network 116. In order to access protected resources 160, user device 105 may attempt to connect to a virtual local area network (VLAN) including devices and resources of private network 116. In particular, user device 105 may connect to WLC device 120 or LC device 125, which are communicatively coupled to gateway device 130. Gateway device 130 may represent a network switch, router, or other node that provides access to other network infrastructures, such as the Internet. Gateway device 130 may pass Transmission Control Protocol/Internet Protocol (TCP/IP) network traffic between private networks 115, 116. In some examples, the various devices of LAN 110 and private networks 115, 116 may be interconnected via virtual private network (VPN) tunnels.

Although private networks 115, 116 are shown as each being communicatively coupled to gateway device 130 in the example of FIG. 1, in other examples, private networks 115, 116 may be coupled to different, respective gateway devices. Likewise, in other examples, WLC device 120 and LC device 125 may be communicatively coupled to different, respective gateway devices.

NAC device 140 may intercept requests for access to private networks 115, 116 by user devices such as user device 105 or other network devices. NAC device 140 may conduct a one-time or periodic authorization and authentication check of user device 105 in response to user device 105 seeking access to private networks 115, 116. NAC device 140 may also enforce one or more policies, such as ensuring that user device 105 has a proper operating system version, recent patches for the operating system or other software installed, an authorized antivirus program, an authorized anti-spyware program, In response to successful authentication and authorization, and before the network device is granted access to protected resources 160. Moreover only user devices 105 that already have a user name and password combination stored on the NAC device 140, policy server 145, authentication server 150 or other authentication module associated with the private network system 100 will be granted network access by the NAC device 140.

Gateway device 130 may perform two-way protocol conversions. For example, gateway device 130 may convert network traffic exiting LAN 110 that is formatted in a local area network protocol format, e.g., the IEEE 802.11 communication protocol, also called WiFi, or the IEEE 802.3 communication protocol, also called Ethernet, to a network communication protocol that is more suitable for the other portions of the private network infrastructure (115, 116), e.g., TCP/IP. Gateway device 130 may also convert network traffic received from regions of private networks 115, 116 that is formatted in the TCP/IP network protocol to a network communication protocol that is suitable for LAN 110, e.g., WiFi or Ethernet.

Network system 100 includes protected resources 160 stored on one or more network devices (not shown) connected to private network 116, in this example. In other examples, protected resources may form part of, e.g., private network 115. Protected resources 160 may include a user email account, a file server for storing documents, an application server for sharing network-enabled versions of common software applications with many user devices, a network printer, a communications server for handling e-mail exchanges, fax communications, remote access to the network, firewalls and/or other internet services, a database server for storing data and for managing requests to store or access data, or the like, to which user device 105 or the user of user device 105 attempts to gain access.

While network system 100 is described as a network including a plurality of network devices, in some examples, one or more of the devices shown in network system 100 may be realized by a single network device, such as a network server or appliance operating software modules and/or divided into virtual networks by virtual network partitions that may each provide separate and/or shared network access control services, separate and/or shared policy management services, separate and/or shared data base services, and separate and/or shared protected resources.

DHCP server device 155 operates according to the DHCP protocol. The DHCP protocol enables user device 105 to request assignment of an Internet Protocol (IP) address for interacting with private networks 115, 116. Typically, when user device 105 is first turned on or when a user requests access to a wired or wireless local area network via one of WLC device 120 or LC device 125, user device 105 establishes a data-link layer (or layer two (L2)) communication channel and whichever one of WLC device 120 or LC 125 the user device is equipped to connect with. After the L2 communication channel is opened, WLC device 120 or LC device 125 recognizes the end user and records a Media Access Control (MAC) address of user device 105. Alternately, user device 105 may be directly connected to gateway device 130, and gateway device 130 may recognize user device 105 and record the MAC address of user device 105.

NAC device 140 monitors such connections though gateway device 130. In response to detecting the L2 communication channel established between user device 105 and WLC device 120 or LC device 125, NAC device 140 requests user authorization credentials (also referred to herein as authentication credentials) from user device 105 over the L2 communication channel. If the user authorization credentials are acceptable, NAC device 140 grants user device 105 limited access to private networks 115, 116 over the L2 communication channel. For example, NAC device 140 may send the authorization credentials to authentication server device 150 for authentication and authorization. The authorization credentials may include one or more of a user name and password for a user of user device 105, a digital certificate of user device 105, or the like.

In the example of FIG. 1, network system 100 includes authentication server device 150. Authentication server device 150 may also be referred to as an authentication, authorization, accounting (AAA) server device. In some examples, functionality attributed to authentication server device 150 may be performed by either one of NAC device 140 or policy server device 145. In some examples, authentication server device 150 performs the Remote Authentication Dial-In Service (RADIUS) client/server protocol. As discussed below, NAC device 140 may include a RADIUS server module, and WLC device 120 may include a RADIUS client module. Generally, the RADIUS protocol is a client/server protocol that runs in the application layer, Layer seven (L7), of the OSI communication model and uses either TCP or UDP for transport. Therefore, the RADIUS protocol is typically not usable over the limited access L2 connection between user device 105 and NAC device 140. As a result, user device 105 may provide an initial request for access to private network 115, 116 using the L2 connection according to Extensible Authentication Protocol over WLAN (EAP) or Extensible Authentication Protocol over LAN (EAPOL), set forth in IEEE 802.1x. User device 105 may initially select EAP or EAPOL based on, e.g., whether user device 105 connects through WLC device 120 or LC device 125.

The RADIUS server module, e.g., executed by authentication server device 150, NAC device 140, and/or policy server device 145, maintains a database of end user names matched with authentication information that can be used to authenticate a user. For example, the RADIUS server module may determine whether a user password provided by a user operating user device 105 is indeed the password associated with the user. The RADIUS server module stores the user device credentials in the database, as well as information such as the MAC address and the current and historical IP addresses assigned to user device 105 and other devices from which the user has requested authorization and authentication, as well as the IP address of corresponding RADIUS client devices.

In the example of the network system 100 shown in FIG. 1, authentication server device 150 may be a separate server connected to any portion of network system 100, or authentication server device 150 may comprise a server software module operating on or otherwise associated with gateway device 130 or operating on or otherwise associated with NAC device 140 or policy server device 145.

The IEEE 802.1x authentication (EAP/EAPOL) involves three parties: a supplicant, an authenticator, and an authentication server. The supplicant in this case refers to user device 105 that attempts to access private networks 115, 116. The term “supplicant” may also refer to an EAP or EAPOL supplicant software module running on user device 105, e.g., executed by a hardware-based processor. The EAP or EAPOL supplicant module provides end user credentials and user device credentials to the EAP/EPOL authenticator, e.g., NAC device 140 or gateway device 130 in the example of FIG. 1. The end user credentials may include a user name and password that relate to a particular user of user device 105 of network system 100. Other credentials may be used in addition or in the alternative, such as a digital certificate, a token, a biometric indicator, two-device authorization information, or the like. In particular, the user must have previously established a user account on private networks 115, 116 and end user credentials may be stored on authentication server device 150 in order to gain access to private networks 115, 116. Otherwise, the end user may be prompted to set up a new user account.

The EAP/EAPOL authenticator is a network device, such as NAC device 140 or gateway device 130. In one example, an EAP authenticator software module is described operating WLC device 120 on the data processor operating on WLC device 120. The EAP authenticator module may include a database module or may use an existing database module operating on WLC device 120 to store end user credentials, such as user name and password and credentials of user device 105, such as MAC address, local area network address, or the like. In addition, the EAP module may further store additional network details on the database, such as date, time, routing information, or the like.

After the L2 communication channel is established, user device 105 broadcasts a discovery request for an IP address to all listening DHCP servers, such as DHCP server device 155. Since user device 105 is a client of LAN 110, the initial discover broadcast is a data link layer L2 broadcast encapsulated in a data link Ethernet frame to make it a LAN broadcast message having as its source address the MAC address of user device 105. In other embodiments, LAN 110 may include a DHCP server device similar to DHCP server device 155.

After DHCP server device 155 receives the LAN broadcast message from user device 105, DHCP server device 155 may respond with a lease offering an IP address and IP configuration information to user device 105. User device 105 may then request an IP address offer by sending a request message to DHCP server device 155. In reply, DHCP server device 155 sends an acknowledgement message to the DHCP client 335 which then establishes the IP address of user device 105.

DHCP server device 155 maintains a database which includes a range of IP addresses stored therein. Typically, a range of IP address is allotted to a particular network portion or network type. The IP address assignment may terminate when a client device to which an IP address is assigned leaves the network or when the network access is no longer being used, e.g., after a period of inactivity or at the end of the lease. When the client device attempts to rejoin the network, the discovery, offer, request, and acknowledgement sequence described above may be repeated. When user device 105 attempts to rejoin the network, DHCP server device 155 may assign user device 105 the same IP address as was previously assigned or a different IP address. After DHCP server device 155 acknowledges the lease request from user device 105, DHCP server device 155 updates its database to associate the assigned IP address, the IP configuration information, and the lease information with the MAC address of user device 105.

In various examples, DHCP server device 155 may include a DHCP server software module executed by a processor of DHCP server device 155 and connected to any or all of private networks 115, 116, gateway device 130, NAC device 140, or policy server device 145. In some examples, network system 100 may include a plurality of DHCP server devices, which may each receive the discover broadcast and respond with respective lease offers. A DHCP client software module operated on each network device may request an IP address assignment according to the process discussed above.

According to the techniques of this disclosure, network system 100 includes policy server device 145. In other examples, the functionality attributed to policy server device 145 may be performed by a software module operating on or a dedicated hardware unit of NAC device 140, gateway device 130, or any other device of network system 100. In this example, policy server device 145 operates to enforce network access policies, such as minimum requirements for user authorization to access protected resources and minimum user device authentication requirements related to compliance with current polices of network system 100. The policies may include static policies, which are independent of changes in network configurations and/or changes in user device connections, and/or dynamic policies that may change as network conditions and user device connections change. Policy server device 145 may determine whether user device 105 complies with static policies once, whereas policy server device 145 may periodically reevaluate whether user device 145 is in compliance with dynamic policies.

Policy server device 145 works with NAC device 140 to control whether user device 105 can connect to private networks 115, 116 and what permissions to grant user device 105 while connected to private networks 115, 116. Policies stored on policy server device 145 may provide various user authentication and authorization levels, which provide different access levels to different end users and to different user devices. In one example, NAC device 140 authorizes user device 105 with limited access to private networks 115, 116 after receiving user credentials, such as a user name, password, digital certificate, and/or other user credentials, such as biometric indicators or the like. However, the limited access only allows L2 access without providing access to any network services or to protected resources 160 until NAC device 140 or policy server device 145 performs a policy compliance check of user device 105 and determines that user device 105 is in compliance with current network policies. More specifically, the limited access limits user device 105 to L2 communications with NAC device 140 through WLC device 120 or LC device 125 and gateway device 130, while preventing user device 105 from accessing any other network resources. In some examples, the limited access may be assignment of user device 105 to a particular VPN or VLAN that does not provide access to, e.g., protected resources 160, instead of a VPN or VLAN that does provide access to protected resources 160.

Policy server device 145 may maintain various policies that relate to, e.g., device type, operating system type and version, virus protection, malware and spyware screening protection types and versions, user application type and version, plug and add-on module type and version, or the like. In addition, some policies may relate to the physical location of user device 105, to temporal factors, e.g., time of day, day of week, season, etc., the local network environment of user device 105 (e.g., LAN 110), an authorization level of the user of user device 105, connection history of user device 105 or the user, or the like.

NAC device 140 and/or policy server device 145 may perform compliance checks of user device 105 in various ways. In one example, NAC device 140 or policy server device 145 may install a persistent compliance agent onto user device 105. In another example, NAC device 140 or policy server device 145 may install a dissolvable or portal-based compliance agent onto user device 105. In yet another example, NAC device 140 may store a compliance verification module in an active directory that may be configured to perform a remote, agentless compliance verification of user device 105.

In response to determining, based on the compliance verification, NAC device 140 (or policy server device 145) determines that user device 105 is compliant with current policies of private networks 115, 116, NAC device 140 may grant greater or full access to private networks 115, 116 to user device 105. For example, NAC device 140 may send a RADIUS change of authorization (CoA) message to, e.g., gateway device 130, to grant greater or full access to user device 105. Additionally or alternatively, NAC device 140 may send a RADIUS disconnect message to, e.g., gateway device 130, to disconnect user device 105 from a VPN or VLAN having restricted access rights, and to instead cause user device 105 to connect to a different VPN or VLAN having greater or full access rights, e.g., to have access to protected resources 160. In some examples, NAC device 140 may require repeated compliance checks of user device 105 to maintain access to protected resources 160.

Alternatively, in response to determining that user device 105 is not compliant with current policies of private networks 115, 116, NAC device 140 may send remediate instructions to user device 105 as to how to comply with the current policies. The remediation instructions may direct user device 105 to a remediation server, which may form part of NAC device 140, or be a separate device (not shown). In general, user device 105 may receive data indicating how to come into compliance, e.g., by downloading one or more software tools, updating installed software and/or an installed operating system, or the like.

After being assigned an IP address, user device 105 establishes a second communication channel with NAC device 140 over the network layer, or layer 3, L3 of the OSI model. Thereafter, NAC device 140 or policy server device 145 communicates with user device 105 over L3 in order to determine if user device 105 is in compliance with one or more policies of network system 100. If user device 105 is found to be in compliance with the policies of network system 100, NAC device 140 grants user device 105 full-access status, e.g., on all OSI layers. NAC device 140 then finds the L2 database record associated with the first L2 communication used to authenticate the user name and password of user device 105 by searching database records for the user device Media Access Control (MAC) address, user name, or the like.

After finding the corresponding L2 record, NAC device 140 updates the L2 database record to include details of the second L3 channel communication such as L3 channel attributes and end point policy compliance details received over the L3 channel communication. The L3 channel attributes may include the user device IP address and a policy compliance status of the user device and may include date and time, gateway and/or local area network controller credentials, session length, or the like. The end point compliance details may include device type, operating system, virus protection status, and other details or a policy compliance PASS FAIL indictor. In particular, after updating the L2 record with the L3 channel attributes and compliance details retrieved over the L3 channel, all of the user device authentication records are associated with the L2 record.

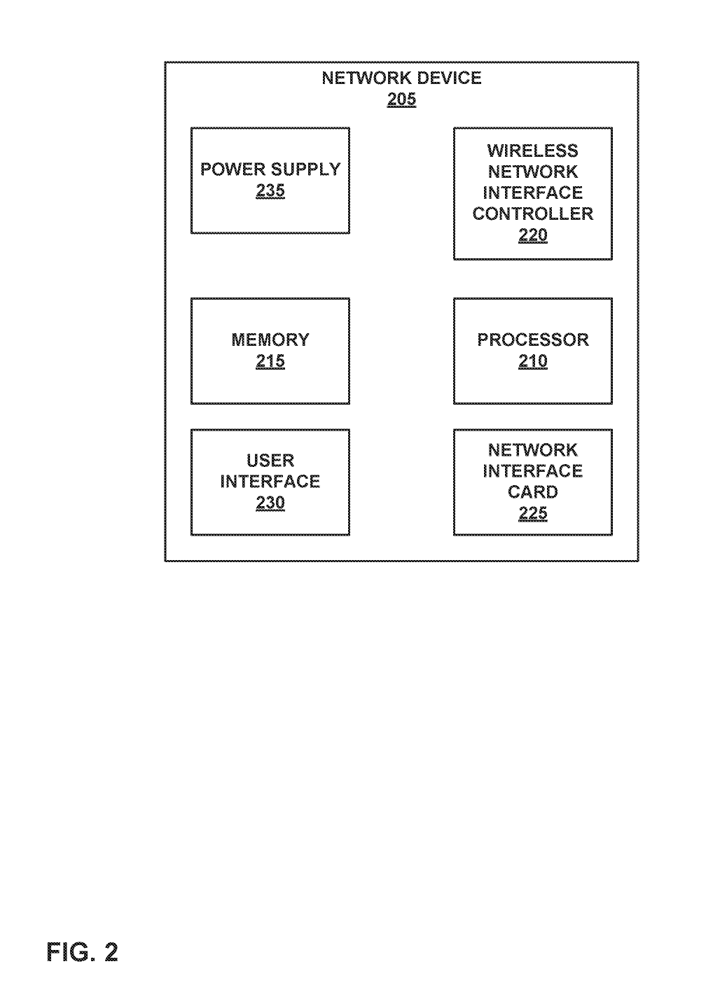

FIG. 2 is a block diagram illustrating an example network device 205 according to the techniques of this disclosure. In general, any or all of user device 105, WLC device 120, LC device 125, gateway device 130, NAC device 140, policy server device 145, DCHP server device 155, authentication server device 150, or other devices, such as devices storing protected resources 160, may be implemented in the general form of network device 205.

In this example, network device 205 includes processor 210 in communication with a memory 215 for storing data. Additionally, network device 205 includes network interface card (NIC) 225, user interface (UI) 230, and power supply 235, each in electrical communication with processor 210.

Network interface card 225 is configured to perform one or more of a variety of network communication protocols for network device 205. For example, user device 105 of FIG. 1 may include two network interface cards or two modules of network interface card 225, with one configured to communicate with WLC device 120 and the other configured to communicate with LC device 125. Similarly, NAC device 140 of FIG. 1 may include a first network interface card configured to communicate over an Internet Protocol (IP) network using the TCP/IP protocol and a second network card configured to communicate over a portion of the private network using a different communication protocol, e.g., IEEE 802.11.

Similarly, user interfaces 230 may vary from device to device, e.g., not all devices will necessarily include a display screen, microphone, or speaker. However, each device at least includes a mechanical, electrical, or software interface that allows a user to gain access to network device 205 to change device settings and exchange data with network device 205 as may be required.

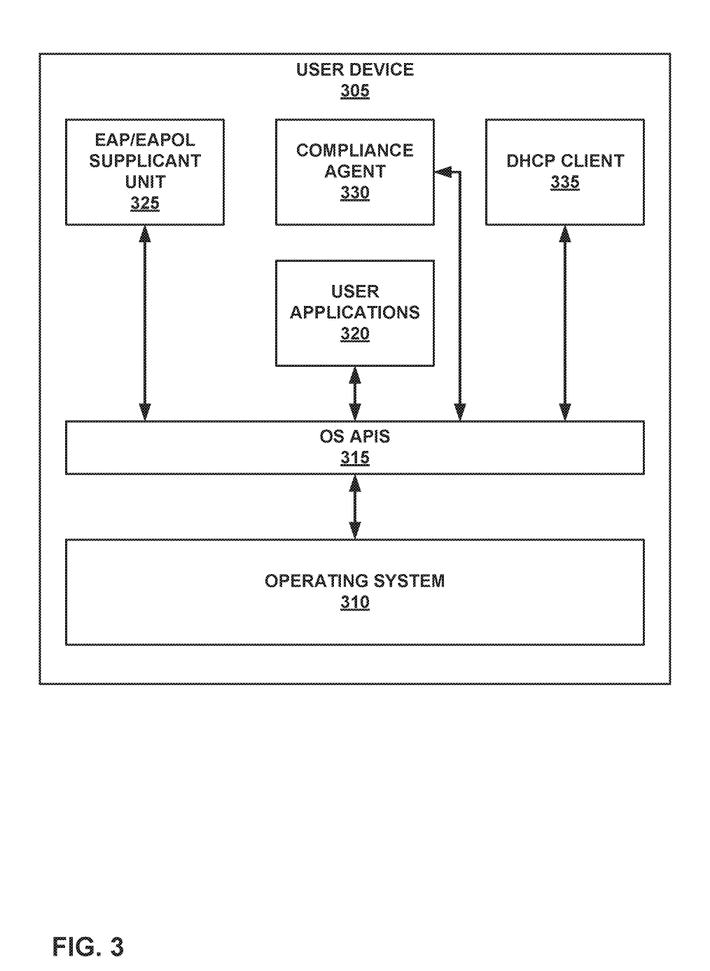

FIG. 3 is a block diagram illustrating an example user device 305 according to the techniques of this disclosure. User device 305 of FIG. 3 includes various software modules executed by a processor (not shown), such as processor 210 of FIG. 2. The software modules of FIG. 3 include EAP/EAPOL supplicant unit 325, compliance agent 330, DHCP client 335, and user applications 320. Additionally, operating system 310 and operating system (OS) application programming interfaces (APIs) may be executed by the processor as well. Operating system 310 controls device resources and manages various system level operations, while operating system APIs 315 provide interfaces between operating system 310 and various other components and software modules, such as user applications 320, EAP/EAPOL supplicant unit 325, compliance agent 330, and DHCP client 325.

EAP/EAPOL supplicant 325 operates to communicate with an EAP/EAPOL authenticator operating on a local area network controller (e.g., WLC device 120, LC device 125, or gateway device 130 of FIG. 1). EAP/EAPOL supplicant unit 325 and the EAP/EAPOL authenticator are configured to communicate over a data-link layer, L2, communication channel to exchange authorization requests and authorization replies over the L2 communication channel.

Additionally, user device 305 includes a compliance agent 330 operable to communicate with NAC device 140 or policy server device 145 (FIG. 1) over a network layer, L3 to communication channel to exchange authentication requests and authentication replies over the L3 communication channel. In this example, compliance agent 330 may be described as “persistent,” in that compliance agent 330 may be persistently installed (e.g., permanently installed until removed by a user).

Compliance agent 330 interfaces with user device operating system 310 to gather compliance information related to user device 305 and to store that gathered compliance information and/or status on user device 105. The compliance status is based on health information of user device 105. The health information may include the current version and type of the operating system, the current version and type of user applications, firewall virus/malware/spyware protection and other relevant application installed onto or running on the user device which may be checked to determine if the user device configuration is in compliance with current policies that need to be verified before gaining access to network system 100. During an authorization process, NAC device 140 (140, 440) communicates with compliance agent 330 requesting a compliance status. The communication may include updating the policies that need to be evaluated for compliance. Compliance agent 330 may report whether user device 305 is compliant or not compliant based on current policies. If new policies need to be evaluated, compliance agent 330 may perform further compliance evaluation before reporting status.

In some examples, compliance agent 330 may be dissolvable or portal-based. In particular, user device 305 may download dissolvable or portal-based compliance agent 330 from a web portal or the like, e.g., operating on NAC device 140, policy server device 145, or authentication server 150 of FIG. 1 to perform a one-time compliance check of user device 305 without permanently installing the dissolvable or portal-based compliance agent 330 on user device 305. The dissolvable or portal-based compliance agent 330 interfaces with the user device operating system 310 or a web browser operating on user device 305 (not shown) to gather compliance information based on the most current policies that need to be evaluated for compliance. Once the compliance information has been evaluated, the dissolvable or portal-based compliance agent 330 may report whether user device 305 is compliant or not based on current policies. User device 305 may periodically update compliance agent 330, e.g., by retrieving update data from policy server device 145, when policies are updated.

According to the 802.1X port-based authentication, EAP/EAPOL supplicant unit 325, in the course of EAP/EAPOL exchanges with WLC 125 or LC 120, provides authentication credentials, such as user name/password or digital certificate, over the L2 communication channel. Thereafter, NAC device 140 or authentication server device 150 determines whether the credentials are authentic. Thus, WLC device 120 may include an EAP authenticator module and RADIUS client module 550. Alternatively, these modules may be present in other devices.

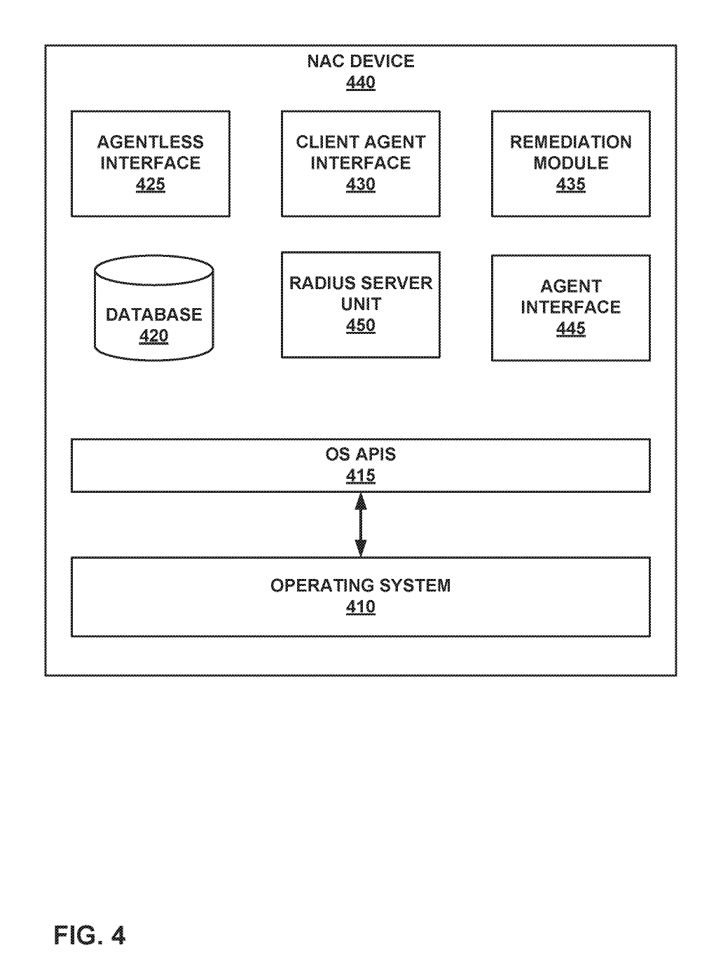

FIG. 4 is a block diagram illustrating an example network access control (NAC) device 440 according to the techniques of this disclosure. FIG. 4 portrays various software modules of NAC device 140, including device operating system 410 for controlling device resources and managing various system level operations, operating system APIs 415 used as interfaces between operating system 410 and various other applications, such as database module 420, agentless verification module 425, dissolvable agent interface module 430, persistent agent interface 445, RADIUS server module 450, and remediation module 435.

Each of agentless verification module 425, dissolvable agent interface module 430, and persistent agent interface 445 may be operable to communicate with user device 105 (FIG. 1) or with compliance agent 330 operating on user device 305 (FIG. 3) to receive policy information and/or a policy status from the user device over a network layer (L3) communication channel and/or to update policy information by transmitting new policy information to the user device or causing policy server device 145 to send the new policy information to the user device. Alternately, policy server device 145 or NAC device 440 may use a web browser or other application to exchange policy information between the user device and policy server device 145 or NAC device 440 over higher OSI model layers, e.g., L4 through L7, using dissolvable agent interface 430 or agentless interface module 425 and a remediation module 435.

As discussed above, the techniques of this disclosure are directed to performing two checks of user device 105 (FIG. 1): authentication and compliance checking. Initially, user device 105 sends authentication information, which authentication server device 150 authenticates, via an L2 channel. As part of the authorization process, NAC device 440 creates an L2 channel record representative of the L2 channel in database module 420 operating on NAC device 440, policy server device 145, or a database module in network system 100 reachable by NAC device 440. The L2 channel record includes L2 channel attributes and user device authorization details at least including a MAC address of user device 105, and the user name of the end user as well as information used to authenticate the user password or a digital certificate. Other L2 channel attributes may include date and time, gateway and/or local area network controller credentials, session length, or the like. Since one policy of the private networks 115, 116 (FIG. 1) is to not provide access to protected resources 160 unless user device 105 (FIG. 1) has been deemed to be compliant with current network policies and since the compliance check is not performed on an L2 communication channel, a higher OSI layer connection is needed, e.g., L3 or higher, in order to perform a compliance check of the user device.

Agentless compliance verification module 425 may be stored in an active directory of NAC device 440. In general, agentless compliance verification module 425 determines whether compliance information of user device 105 complies with policies of private networks 115, 116. More particularly, agentless compliance verification module 425 retrieves the compliance information of user device 105 via an L3 communication channel. NAC device 440 executes agentless compliance verification module 425 to perform a remote, agentless compliance verification of user device 105 (FIG. 1), after the user of user device 105 has been authorized. Agentless compliance module 425 interfaces with the user device operating system 310 or with a web browser operating on the user device to gather compliance information based on the most current policies that need to be evaluated for compliance. Once the compliance information has been evaluated, agentless compliance module 425 may report that user device 105 is compliant or not compliant based on current policies. Additionally, agentless compliance module 425 is periodically updated, e.g., by policy server device 145 when policies are updated. Although described with respect to agentless compliance module 425, agent interface 445 may perform similar functionality to that described with respect to agentless compliance module 425. In particular, agent interface 445 may interact with an agent installed on user device 105 (either temporarily or permanently), rather than performing this functionality in an agentless fashion. In some examples, agent interface 445 may provide the agent (e.g., software instructions for the agent) to user device 105.

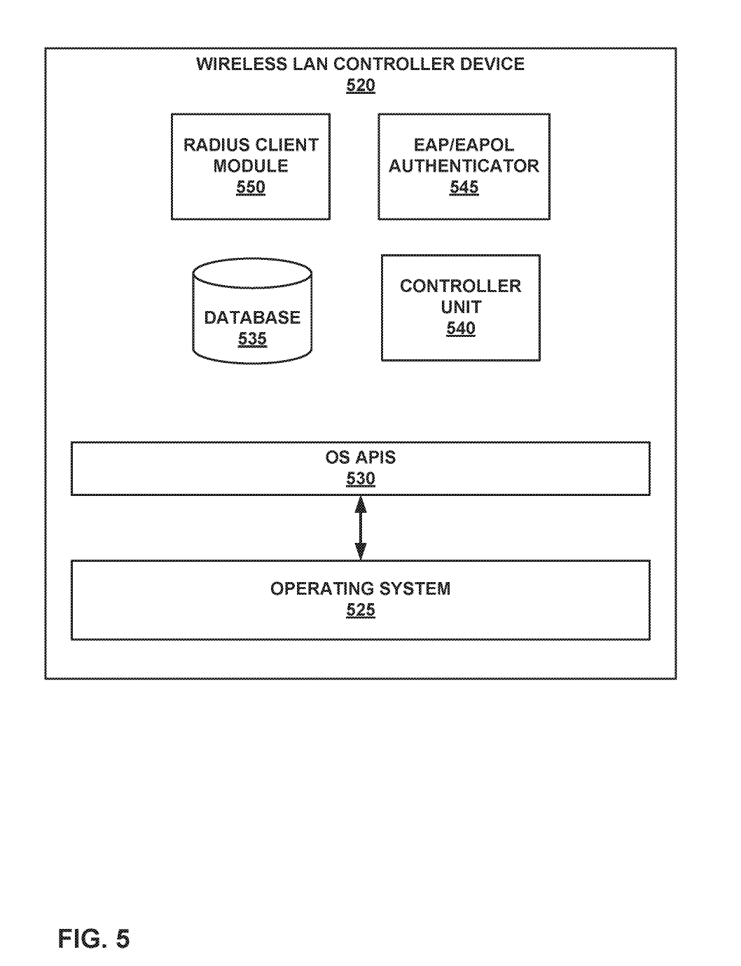

FIG. 5 is a block diagram illustrating an example wireless local area network (LAN) controller (WLC) device 520 according to the techniques of this disclosure. FIG. 5 depicts example software/firmware modules executed by a data processor of an example wireless local area network (LAN) controller device 520, such as WLC device 120 of FIG. 1. LC device 125 or gateway device 130 may execute similar software modules.

The software modules of WLC device 520 in the example of FIG. 5 include device operating system 525 for controlling device resources and managing various system level operations, operating system APIs 530 used as a software interface between operating system 525 and various other applications, such as database module 535, Ethernet or Wireless Ethernet controller unit 540, EAP/EAPOL authenticator module 545, and RADIUS client module 550 for interfacing with a RADIUS server module.

As discussed above, NAC device 140 (FIG. 1) may determine whether user device 105 is both authenticated and in compliance with policies. In some examples, RADIUS client module 550 of WLC device 520 may receive user credentials of user device 105. After RADIUS client module 550 receives the user credentials, RADIUS client module 550 makes a series of exchanges with authentication server device 150 provide the user credentials and to authenticate the user credentials. If authentication server device 150 determines that the user credentials are authentic, RADIUS client module 550 receives an ACCESS ACCEPT reply from authentication server device 150. Additionally, the ACCESS ACCEPT reply includes an access level, which in the techniques of this disclosure is initially “limited access.” If the user credentials are not authentic, RADIUS client module 550 receives an ACCESS DENY reply from authentication server device 150. In some cases, RADIUS client module 550 receives an ACCESS CHALLENGE message requesting more information in order to allow access, which RADIUS client module 550 sends back to user device 105.

Whatever RADIUS response is received, RADIUS client module 550 reformats the RADIUS response and relays the reformatted response to EAP/EAPOL authenticator 545, which relays the reformatted response to the EAP/EAPOL supplicant unit 325 via the L2 communication channel. If the RADIUS response is ACCESS ACCEPT with limited access, WLC device 520 connects user device 150 to LAN 110 over a L2 communication channel, prompting user device 105 to initiate the DHCP request process as described above. After user device 105 has been assigned an IP address by DHCP server device 155 (FIG. 1), user device 105 establishes a network layer link L3 communication channel between user device 105 and NAC device 140 with limited access to network system 100.

After the L3 commutation channel is established, NAC device 140 merges the L2 and L3 communication sessions with details of the L2 communication channel and the L3 communication channel stored on a database operating on NAC device 140 or policy server device 145. As noted above, the authenticator server 150 is a RADIUS server and a RADIUS client module 550 is operating on the same device that operates the EAP/EAPOL authenticator module 545. Additionally, policy compliance information may also be exchanged between EAP/EAPOL authenticator module 545 and user device 105, which EAP/EAPOL authenticator module 545 provides to NAC device 140. As discussed above, if this policy compliance information demonstrates that user device 105 complies with the policies, NAC device 140 may grant full access to user device 105.

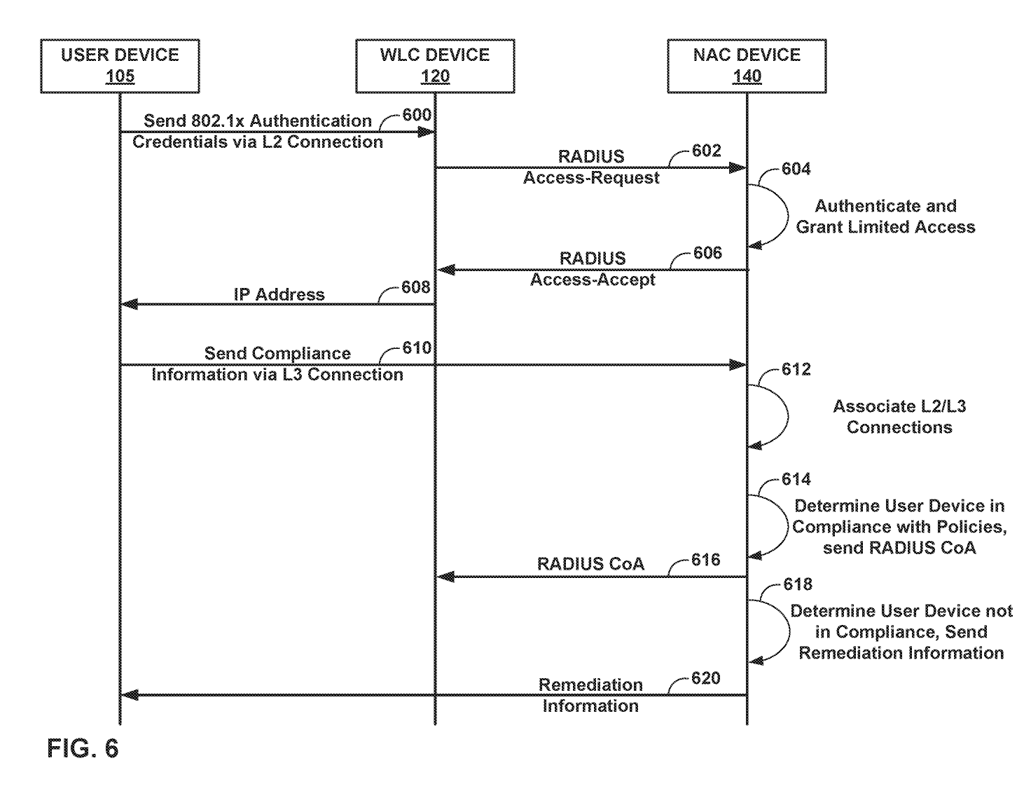

FIG. 6 is a flowchart illustrating an example method for authenticating and authorizing a user device to access one or more protected resources according to the techniques of this disclosure. The steps of the method of FIG. 6 are described with respect to various components and devices of FIGS. 1-5. Although certain components are shown, other components described above may be substituted. For example, actions attributed to WLC device 120 may instead be performed by LC device 125.

Initially, EAP/EAPOL supplicant unit 325 operating on user device 105 prompts user of user device 105 to enter a user name and password and/or to provide a digital certificate associated with gaining access to network system 100. EAP/EAPOL supplicant unit 325 operating on user device 105 then sends a request to access LAN 110 via any one of WLC device 120, LC device 125 (600). EAP/EAPOL supplicant unit 325 sends the request over a data link layer (L2) communication channel. EAP/EAPOL supplicant unit 325 structures the request to access LAN 110 to include the MAC address or other address used by the local rea network of user device 105, the user name, and some information that the user password can be derived from or that the digital certificate can be derived from. In some examples, user device 105 sends the request for access to WLC device 120 using the 802.11x communication protocol.

WLC device 120 receives the request from user device 105 and forms a RADIUS access request from the received request. More particularly, EAP authenticator 545 operating on WLC device 120 receives the request for access and the end user information from the EAP authenticator 545 and relays the access request and end user information to a RADIUS client module 550 operating on the WLC. WLC device 120 then sends the RADIUS access request to NAC device 140 (602).

RADIUS server module 450 operating on NAC device 140 parses end user information stored on database 420 to authenticate that the end user information received from the user device in the RADIUS access request agrees with end user information stored on database 420 (604). If the end user information is authenticated, NAC device 140 grants user device 150 access to network system 100 with limited access by sending, e.g., a RADIUS access accept message (606) to WLC device 120. In some examples, NAC device 140 may instead send the end user information to authentication server device 105 for authentication, instead of authenticating the end user information itself. Additionally, NAC device 140 creates and stores data for the L2 communication channel and the end user information and user device information related to the L2 communication channel in NAC database 420.

Assuming the user credentials were authenticated, WLC device 120 translates the RADIUS access accept message with limited access into a message formatted according to EAP or EAPOL protocol and relays the translated message to EAP/EAPOL authenticator 545. EAP/EAPOL authenticator 545 relays the translated message to EAP/EAPOL supplicant unit 325 operating on user device 105.

User device 105 may then access network system 100 with limited access. Accordingly, DHCP client 335 operating on user device 105 responds by broadcasting a DHCP request over the data layer link L2. DHCP server device 155 responds to the DHCP request with an offer of an IP address and IP environment information, over the data layer link L2 (608). DHCP client 335 operating on user device 105 receives IP address information provided by DHCP server device 155 and sends an accept message to DHCP server device 155 over the data layer link L2. DHCP server device 155 sends an acknowledgement message to the DHCP client 335 over the data link layer L2 and records the IP address lease information associated with user device 105.

User device 105 or compliance agent 330 operating on the user device 305 then initiates a connection with NAC device 140 over a network layer L3 communication channel. User device 105 or compliance agent 330 operating on user device 105 exchanges one or more messages with NAC device 140 and/or policy server device 145 to determine a policy status to NAC device 140 over the network layer L3 communication channel. That is, user device 105 sends compliance information to NAC device 140 over the L3 communication channel (610).

NAC device 140 updates the policy status information related to user device 105 in a database record associated with the L3 communication channel, and if the policy status is authenticated, NAC device 140 grants user device 105 full access to network system 100. NAC device 140 finds the database record that relates to the L2 communication channel that matches the user name password and MAC address of the user device and updates the L2 communication channel records in database 420 with the compliance status received over the L3 communication channel and other information that relates to the L3 communication exchanges (612).

If the compliance status is satisfactory, i.e., if NAC device 140 determines that user device 105 is in compliance with applicable policies (614), NAC device 140 sends an authentication complete message (i.e., a RADIUS change of access (CoA) message) to WLC device 120 (616).

On the other hand, if the compliance status is not satisfactory, i.e., if NAC device 140 determines that user device 105 is not in compliance with applicable policies (618), NAC device 140 may provide remediation information to user device 105 (620). In response, user device 105 may use the remediation information to become compliant, e.g., to download and install applicable software or updates to installed software. After downloading and installing such software or updates, user device 105 may once again provide compliance information to NAC device 140 per step (610), and NAC device 140 may reevaluate whether to grant user device 105 full access, according to the techniques discussed above.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media. Computer readable storage media, which is tangible and non-transitory, may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media. It should be understood that the term “computer-readable storage media” refers to physical storage media, and not signals, carrier waves, or other transient media.

Various examples have been described. These and other examples are within the scope of the following claims.

What is claimed is:

1. A method comprising:
receiving, by a network access control (NAC) device that enforces one or more policies for accessing one or more remote network devices, authentication credentials from a user device via an OSI layer 2 (L2) connection including first identification information of the user device;
authenticating, by the NAC device, the user device using the authentication credentials;
receiving, by the NAC device, compliance information from the user device via an OSI layer 3 (L3) connection including second identification information of the user device;
associating, by the NAC device, the L2 connection with the L3 connection using the first identification information and the second identification information; and
in response to determining that the compliance information satisfies the one or more policies, authorizing, by the NAC device, the user device to access the one or more remote network devices.

2. The method of claim 1, wherein receiving the authentication credentials comprises receiving the authentication credentials according to extensible authentication protocol (EAP) or extensible authentication protocol over LAN (EAPOL).

3. The method of claim 1, wherein receiving the authentication credentials comprises receiving security assertion markup language (SAML) formatted data representing the authentication credentials.

4. The method of claim 1,
wherein receiving the compliance information comprises:
assigning the user device to a temporary virtual local area network (VLAN) with limited access rights; and
initiating the L3 connection with the user device, and
wherein authorizing the user device to access the one or more remote network devices comprises assigning the user device to a second VLAN with full access rights to the one or more remote network devices.

5. The method of claim 4, wherein assigning the user device to the second VLAN further comprises sending a remote authentication dial-in user service (RADIUS) change of authentication (CoA) message to assign the user device to the second VLAN.

6. The method of claim 4, wherein assigning the user device to the second VLAN further comprises sending a remote authentication dial-in user service (RADIUS) disconnect message to disconnect the user device from the temporary VLAN.

7. The method of claim 1, wherein authenticating the user device comprises:
sending the authentication credentials to an authentication server; and
receiving, from the authentication server, an indication that the authentication credentials are authentic.

8. The method of claim 7, wherein the authentication server comprises one of a remote authentication dial-in user service (RADIUS) server, a lightweight directory access protocol (LDAP) server, or an active directory (AD) server.

9. The method of claim 1, wherein the compliance information comprises information indicating one or more of an operating system version for the user device, an antivirus version installed on the user device, an anti-spyware version installed on the user device, an on-device firewall installed on the user device, operating system patches installed on the user device, or software patches installed on the user device.

10. The method of claim 1, wherein the first identification information comprises a media access control (MAC) address of the user device, and wherein the second identification information comprises the MAC address of the user device.

11. The method of claim 1, wherein the first identification information comprises at least one of a user name and password or a digital certificate of the user device, and wherein the second identification information comprises the user name and password or the digital certificate of the user device.

12. The method of claim 1, further comprising sending instructions to the user device to cause the user device to install a compliance agent, wherein receiving the compliance information comprises receiving the compliance information from the compliance agent of the user device.

13. The method of claim 1, further comprising, in response to determining that the compliance information does not satisfy one or more of the policies, sending data indicating a remediation server from which to retrieve one or more programs or updates to bring the user device into compliance with the one or more policies.

14. A network access control (NAC) device that enforces one or more policies for accessing one or more remote network devices, the NAC device comprising:
one or more network interfaces configured to communicate with a user device via a network; and
one or more processors implemented in circuitry and configured to:
receive authentication credentials from the user device over an OSI layer 2 (L2) connection via the one or more network interfaces, the authentication credentials including first identification information of the user device;
authenticate the user device using the authentication credentials;
receive compliance information from the user device over an OSI layer 3 (L3) connection via the one or more network interfaces, the compliance information including second identification information of the user device;
associate the L2 connection with the L3 connection using the first identification information and the second identification information; and
in response to determining that the compliance information satisfies the one or more policies, authorize the user device to access the one or more remote network devices.

15. The NAC device of claim 14, wherein the one or more processors are configured to receive the authentication credentials according to extensible authentication protocol (EAP) or extensible authentication protocol over LAN (EAPOL).

16. The NAC device of claim 14, wherein the one or more processors are configured to receive security assertion markup language (SAML) formatted data representing the authentication credentials.

17. The NAC device of claim 14, wherein the one or more processors are configured to assign the user device to a temporary virtual local area network (VLAN) with limited access rights when the authentication credentials are authenticated, initiate the L3 connection with the user device, and to assign the user device to a second VLAN with full access rights to the one or more remote network devices when the compliance information satisfies the one or more policies.

18. The NAC device of claim 17, wherein to assign the user device to the second VLAN, the one or more processors are configured to send a remote authentication dial-in user service (RADIUS) change of authentication (CoA) message to assign the user device to the second VLAN.

19. The NAC device of claim 17, wherein to assign the user device to the second VLAN, the one or more processors are configured to send a remote authentication dial-in user service (RADIUS) disconnect message to disconnect the user device from the temporary VLAN.

20. The NAC device of claim 14, wherein the first identification information comprises a media access control (MAC) address of the user device, and wherein the second identification information comprises the MAC address of the user device.

21. A computer-readable storage medium comprising instructions that, when executed, cause a processor of a network access control (NAC) device that enforces one or more policies for accessing one or more remote network devices to:
receive authentication credentials from the user device over an OSI layer 2 (L2) connection via the one or more network interfaces, the authentication credentials including first identification information of the user device;
authenticate the user device using the authentication credentials;
receive compliance information from the user device over an OSI layer 3 (L3) connection via the one or more network interfaces, the compliance information including second identification information of the user device;
associate the L2 connection with the L3 connection using the first identification information and the second identification information; and
in response to determining that the compliance information satisfies the one or more policies, authorize the user device to access the one or more remote network devices.
